(19) United States
(12) Patent Application Publication
(10) Pub. No.: US 2008/0149480 A1
(43) Pub. Date: Jun. 26, 2008

(54) GEL FORMATION TO REDUCE HEMATOCRIT SENSITIVITY IN ELECTROCHEMICAL TEST

(75) Inventor: Douglas E. Bell, Coral Springs, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Home Diagnostics, Inc.

(21) Appl. No.: 11/957,754

(22) Filed: Dec. 17, 2007

Related U.S. Application Data
(60) Provisional application No. 60/876,477, filed on Dec. 22, 2006.

(51) Int. Cl. G01N 27/28; B05D 5/12

(52) U.S. Cl. 204/403.14; 427/58

(57) ABSTRACT

Devices for determining the concentration of a constituent in a physiological sample that comprise gel matrices to filter red blood cells are provided. Examples of such devices include a biosensor comprising, on a support substrate, a sample reception region for receiving a blood sample; at least one electrode; and a reaction reagent system that is located in a gel matrix. The gel matrix disclosed herein is sufficient to prevent at least some of the red cells in the blood sample from contacting the electrode, and thus reduce the hematocrit sensitivity in the measurement.

This application claims priority to U.S. Provisional Patent Application No. 60/876,477 filed on Dec. 22, 2006, the contents of which is incorporated herein by reference.

The present disclosure relates to the field of diagnostic testing systems for measuring the concentration of an analyte in a blood sample, including biosensors comprising gel formulations for filtering red cells, and thus reducing hematocrit sensitivity. The present disclosure also relates to methods for measuring an analyte concentration using such biosensors.

Electrochemical sensors have long been used to detect and/or measure the presence of substances in a fluid sample. In the most basic sense, electrochemical sensors comprise a reagent mixture containing at least an electron transfer agent (also referred to as an “electron mediator”) and an analyte specific bio-catalytic protein (e.g. a particular enzyme), and one or more electrodes. Such sensors rely on electron transfer between the electron mediator and the electrode surfaces and function by measuring electrochemical redox reactions. When used in an electrochemical biosensor system or device, the electron transfer reactions are transformed into an electrical signal that correlates to the concentration of the analyte being measured in the fluid sample.

The use of such electrochemical sensors to detect analytes in bodily fluids, such as blood or blood derived products, tears, urine, and saliva, has become important, and in some cases, vital to maintain the health of certain individuals. In the health care field, people such as diabetics, for example, have a need to monitor a particular constituent within their bodily fluids. A number of systems are available that allow people to test a body fluid, such as, blood, urine, or saliva, to conveniently monitor the level of a particular fluid constituent, such as, for example, cholesterol, proteins, and glucose. Patients suffering from diabetes, a disorder of the pancreas where insufficient insulin production prevents the proper digestion of sugar, have a need to carefully monitor their blood glucose levels on a daily basis. Routine testing and controlling blood glucose for people with diabetes can reduce their risk of serious damage to the eyes, nerves, and kidneys.

A number of systems permit people to conveniently monitor their blood glucose levels, and such systems typically include a test strip where the user applies a blood sample and a meter that “reads” the test strip to determine the glucose level in the blood sample. An exemplary electrochemical biosensor is described in U.S. Pat. No. 6,743,635 ('635 patent), which is incorporated by reference herein in its entirety. The '635 patent describes an electrochemical biosensor used to measure glucose level in a blood sample. The electrochemical biosensor system is comprised of a test strip and a meter. The test strip includes a sample chamber, a working electrode, a counter electrode, and fill-detect electrodes. A reagent layer is disposed in the sample chamber. The reagent layer contains an enzyme specific for glucose, such as, glucose oxidase, and a mediator, such as, potassium ferricyanide or ruthenium hexaamine. When a user applies a blood sample to the sample chamber on the test strip, the reagents react with the glucose in the blood sample and the meter applies a voltage to the electrodes to cause redox reactions. The meter measures the resulting current that flows between the working and counter electrodes and calculates the glucose level based on the current measurements.

Biosensors configured to measure a blood constituent may be affected by the presence of certain blood components that may undesirably affect the measurement and lead to inaccuracies in the detected signal. This inaccuracy may result in an inaccurate glucose reading, leaving the patient unaware of a potentially dangerous blood sugar level, for example. As one example, the particular blood hematocrit level (i.e. the percentage of the amount of blood that is occupied by red blood cells) can erroneously affect a resulting analyte concentration measurement.

Variations in a volume of red blood cells within blood can cause variations in glucose readings measured with disposable electrochemical test strips. Typically, a negative bias (i.e., lower calculated analyte concentration) is observed at high hematocrits, while a positive bias (i.e., higher calculated analyte concentration) is observed at low hematocrits. At high hematocrits, for example, the red blood cells may impede the reaction of enzymes and electrochemical mediators, reduce the rate of chemistry dissolution since there less plasma volume to solvate the chemical reactants, and slow diffusion of the mediator. These factors can result in a lower than expected glucose reading as less current is produced during the electrochemical process. Conversely, at low hematocrits, less red blood cells may affect the electrochemical reaction than expected, and a higher measured current can result. In addition, the blood sample resistance is also hematocrit dependent, which can affect voltage and/or current measurements.

Several strategies have been used to reduce or avoid hematocrit based variations on blood glucose readings as described in U.S. patent application Ser. No. 11/401,458, which is incorporated by reference herein in its entirety. For example, test strips have been designed to incorporate meshes to remove red blood cells from the samples, or have included various compounds or formulations designed to increase the viscosity of red blood cell and attenuate the affect of low hematocrit on concentration determinations. Further, biosensors have been configured to measure hematocrit by measuring optical variations after irradiating the blood sample with light, or measuring hematocrit based on a function of sample chamber fill time. These methods have the disadvantages of increasing the cost and complexity of test strips and may undesirably increase the time required to determine an accurate glucose measurement.

In addition, alternating current (AC) impedance methods have also been developed to measure electrochemical signals at frequencies independent of a hematocrit effect. Such methods suffer from the increased cost and complexity of advanced meters required for signal filtering and analysis.

An additional prior hematocrit correction scheme is described in U.S. Pat. No. 6,475,372, which is incorporated by reference herein in its entirety. In that method, a two potential pulse sequence is employed to estimate an initial glucose concentration and determine a multiplicative hematocrit correction factor. A hematocrit correction factor is a particular numerical value or equation that is used to correct an initial concentration measurement, and may include determining the product of the initial measurement and the determined hematocrit correction factor. Data processing using this technique, however, is complicated because both a hematocrit correction factor and an estimated glucose concentration must be determined to establish the corrected glucose value. In addition, the time duration of the first step greatly increases the overall test time of the biosensor, which is undesirable from the user's perspective.

Accordingly, it is desired to improve on existing electrochemical biosensor technologies so that measurements are more accurate by being less sensitive to hematocrit levels in the blood sample.

### SUMMARY OF THE INVENTION

In view of the foregoing, there is disclosed biosensors for measuring a constituent concentration in blood, which comprises a unique gel matrix for filtering red blood cells. In addition to filtering red cells, the gel matrix prevents at least some of the red cells in the blood sample from contacting the electrode, and thus reduces inaccuracies in glucose readings associated with variations in hematocrit levels. The biosensors disclosed herein typically comprise a sample reception region for receiving a blood sample, at least one electrode, and a reaction reagent system.

In one embodiment, the reaction reagent system comprises, in a gel matrix, an oxidation-reduction enzyme specific for the constituent to be measured and at least one electron mediator capable of being reversibly reduced and oxidized such that an electrochemical signal resulting from the reduction or oxidation is related to the constituent concentration in the blood sample.

Also disclosed herein are methods of making these inventive biosensors. An electrochemical biosensor and methods of making it according to the present disclosure are described in U.S. Pat. No. 6,743,635 ('635 patent), which was previously incorporated by reference.

Also disclosed is a method of measuring a constituent concentration in blood using the inventive biosensor. This method comprises contacting the disclosed biosensor with a blood sample, wherein the gel matrix that has been deposited on the biosensor, absorbs red blood cells found in the sample. The gel matrix is sufficient to prevent at least some of the red cells in the blood sample from contacting the electrode, and thus adversely effecting the resulting measurement. In one embodiment, the gel is in a dehydrated form and is rehydrated upon contact with the blood sample.

In accordance with these and other objects which will become apparent hereinafter, the instant invention will now be described with particular reference to the accompanying drawings.

It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several embodiments of the invention and together with the description, serve to explain the principles of the invention.

FIG. 1 is a top plan view of a test strip according to an illustrative embodiment of the invention.

FIG. 2 is a cross-sectional view of the test strip of FIG. 1, taken along line 2-2.

FIG. 3 is a graphical representation of the reduced effects of hematocrit level on a sample comprising 100 mg/dL glucose using a biosensor according to the present disclosure.

FIG. 4 is a graphical representation of the reduced effects of hematocrit level on a sample comprising 400 mg/dL glucose using a biosensor according to the present disclosure.

FIG. 5 is a schematic showing top views (5a) and side views (5b) of location of the inventive gel matrix on a biosensor according to one embodiment of the present disclosure.

### DESCRIPTION OF THE EMBODIMENTS

Reference will now be made in detail to the exemplary embodiments of the invention, examples of which are illustrated in the accompanying drawings.

In accordance with an exemplary embodiment, a biosensor manufacturing method is described. Many industries have a commercial need to monitor the concentration of particular constituents in a fluid. The oil refining industry, wineries, and the dairy industry are examples of industries where fluid testing is routine. In the health care field, people such as diabetics, for example, need to monitor various constituents within their bodily fluids using biosensors. A number of systems are available that allow people to test a body fluid (e.g. blood, urine, or saliva), to conveniently monitor the level of a particular fluid constituent, such as, for example, cholesterol, proteins or glucose.

For purposes of this disclosure, “distal” refers to the portion of a test strip further from the fluid source (i.e. closer to the meter) during normal use, and “proximal” refers to the portion closer to the fluid source (e.g. a finger tip with a drop of blood for a glucose test strip) during normal use. The test strip of the present specification can be formed using materials and methods described in commonly owned U.S. Pat. No. 6,743,635, which is hereby incorporated by reference in its entirety. The test strip can include a tapered section that is narrowest at the proximal end, or can include other indicia in order to make it easier for the user to locate the first opening and apply the blood sample.

As mentioned previously, biosensors may inaccurately measure a particular constituent level in blood due to unwanted affects of certain blood components on the method of measurement. For example, the hematocrit level (i.e. the percentage of blood occupied by red blood cells) in blood can erroneously affect a resulting analyte concentration measurement. Thus, it may be desirable to remove or reduce the red blood cells in order to reduce the sensitivity of the blood sample to hematocrit.

In accordance with one exemplary embodiment of the present invention, a gel matrix sufficient for absorbing red blood cell in the blood sample is applied to the biosensor. For example, a polyvinyl alcohol (PVA) gel may be applied to the biosensor in a dehydrated form. In addition to PVA-based gels, other types of gels that might be used according to the present disclosure include those comprising polyacrylates and gelatin. Upon contact with the blood sample, particularly the water contained therein, the gel rehydrates and absorbs the red cells. Once within the gel matrix, the red blood cells do not reach the electrode and effect the measurement.

In one non-limiting embodiment, the biosensor according to the present disclosure comprises, on a support substrate:

a sample reception region for receiving a blood sample;

at least one electrode; and

a reaction reagent system comprising, in a gel matrix:

an oxidation-reduction enzyme specific for the constituent; and

at least one electron mediator capable of being reversibly reduced and oxidized such that an electrochemical signal resulting from the reduction or oxidation is related to the constituent concentration in the blood sample,

wherein the gel matrix is sufficient to prevent at least some of the red cells in the blood sample from contacting the electrode.

In one embodiment, the inventive biosensor may comprise one or more electrodes, such as a working electrode and a counter (or in an exemplary embodiment, proximal) electrode, can be disposed on a substrate or support material, optionally along with one or more fill-detect electrodes.

The electrodes used in the disclosed biosensor may be comprised of traditional conducting electrode materials, such as metals, including without limitation gold, platinum, rhodium, palladium, silver, iridium, steel, metallorganics, and mixtures thereof. The electrodes may also comprise one or more semiconducting materials, such as tin oxide, indium oxide, titanium dioxide, manganese oxide, iron oxide, and zinc oxide, or combinations of these materials. In one embodiment, semiconducting electrodes, such as zinc oxide or tin oxide doped with indium or indium oxide doped with zinc or tin, can be used.

Non-limiting examples of the support material include polymeric or plastic materials, such as polyethylene terepthalate (PET), glycol-modified polyethylene terepthalate (PETG), polyvinyl chloride (PVC), polyurethanes, polyamides, polyimide, polycarbonates, polyesters, polystyrene, or copolymers of these polymers, as well as ceramics, such as such as oxides of silicon, titanium, tantalum and aluminum, and glass. In addition to the insulating properties, the particular support material is chosen based on temperature stability, and the desired mechanical properties, including flexibility, rigidity, and strength.

The reagent layer is also disposed on the support material and may contact at least the working electrode. The reagent layer, which in one embodiment is located within the gel matrix described herein, may include an enzyme, such as glucose oxidase or glucose dehydrogenase, and a mediator, such as potassium ferricyanide or ruthenium hexamine. Mention is also made, in a non-limiting manner, of other mediators that may be used in accordance with the present disclosure, including, phenazine ethosulphate, phenazine methosulfate, pheylenediamine, 1-methoxy-phenazine methosulfate, 2,6-dimethyl-1,4-benzoquinone, 2,5-dichloro-1,4-benzoquinone, indophenols, osmium bipyridyl complexes, tetrathiafulvalene or phenanonthroline quinone.

The reagent layer may react with glucose in the blood sample in order to determine the particular glucose concentration. In this embodiment, the enzyme component of the redox reagent system is a glucose oxidizing enzyme, such as glucose oxidase, PQQ-dependent glucose dehydrogenase and NAD-dependent glucose dehydrogenase.

It is also possible that glucose oxidase or glucose dehydrogenase is used in the reagent layer. In such an embodiment, during operation the glucose oxidase initiates a reaction that oxidizes the glucose to gluconic acid and reduces a mediator such as ferricyanide or ruthenium hexamine. In one embodiment, when an appropriate voltage is applied to a working electrode relative to a counter electrode, the ferrocyanide is oxidized to ferricyanide, thereby generating a current that is related to the glucose concentration in the blood sample.

In another embodiment, the electron mediator comprises a ruthenium containing material, such as ruthenium hexaamine (III) trichloride. When ruthenium hexaamine [Ru(NH₃)₆]³⁺ is used, it is reduced to [Ru(NH₃)₆]²⁺. When an appropriate voltage is applied to the working electrode, relative to the counter electrode, the electron mediator is oxidized. When ruthenium hexaamine [Ru(NH₃)₆]²⁺ is used, it is oxidized to [Ru(NH₃)₆]³⁺, thereby generating a current that is related to the glucose concentration in the blood sample.

It has been discovered that the use of certain optional ingredients can lead to reagent formulations containing Ru mediator that spread more uniformly and that are more tolerant of slight misalignment of dispense location. Such uniform spreading of reagent on the sensors tend to eliminate thicker deposition typically occurring on the edge of reagent deposition (referred to as the “coffee ring” or “igloo” effect). As a result, sensor repeatability or precision performance is improved and outlier strips due to uneven reagent deposition or misaligned deposition are reduced or eliminated. For example, formulation containing polyvinyl alcohol (PVA) and/or Natrosol (a hydroxyethylcellulose from Aqualon, a division of Hercules, Inc.) and Triton X-100 or Silwet will produce very uniform reagent spreading.

It is contemplated that other reagents and/or other mediators can be used to facilitate detection of glucose and other constituents in blood and other body fluids. The reagent layer can also include other components, such as buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485).

Further, a variety of other mediator agents are known in the art that may be used in certain embodiments of the present invention, including without limitation phenazine ethosulphate, phenazine methosulfate, pheylenediamine, 1-methoxy-phenazine methosulfate, 2,6-dimethyl-1,4-benzoquinone, 2,5-dichloro-1,4-benzoquinone, indophenols, osmium bipyridyl complexes, tetrathiafulvalene and phenanonthroline quinone.

An additional electron mediator chosen from brilliant cresyl blue, gentisic acid (2,5-dihydroxybenzoic acid), and 2,3,4-trihydroxybenzoic acid, may also be used in accordance with the present disclosure.

In addition to glucose, the electrochemical biosensors described herein can be used to monitor other constituent or analyte concentration in a non-homogeneous bodily fluid, such as blood. Non-limiting examples of such analytes include analytes of cholesterol, lactate, osteoporosis, ketone, theophylline, and hemoglobin A1c. The specific enzyme present in the fluid depends on the particular analyte for which the biosensor is designed to detect, where representative enzymes include: cholesterol esterase, cholesterol oxidase, lipoprotein lipase, glycerol kinase, glycerol-3-phosphate oxidase, lactate oxidase, lactate dehydrogenase, pyruvate oxidase, alcohol oxidase, bilirubin oxidase, uricase, and the like.

Depending on the analyte of interest, the reaction reagent system may include such optional ingredients as buffers, surfactants, and film forming polymers. Examples of buffers that can be used in the present invention include without limitation potassium phosphate, citrate, acetate, TRIS, HEPES, MOPS and MES buffers. In addition, typical surfactants include non-ionic surfactant such as Triton X-100® and Surfynol®, anionic surfactant and zwitterionic surfactant. Triton X-100® (an alkyl phenoxy polyethoxy ethanol), and Surfynol® are a family of detergents based on acetylenic diol chemistry. In addition, the reaction reagent system may optionally include wetting agents, such as organosilicone surfactants, including Silwet® (a polyalkyleneoxide modified heptamethyltrisiloxane from GE Silicones).

The reaction reagent system further optionally comprises at least one polymeric binder material. Such materials are generally chosen from the group consisting of hydroxypropyl-methyl cellulose, sodium alginate, microcrystalline cellulose, polyethylene oxide, polyethylene glycol (PEG), polypyrrolidone, hydroxyethylcellulose, or polyvinyl alcohol.

Other optional components include dyes that do not interfere with the glucose reaction, but facilitates inspection of the deposition. In one non-limiting embodiment, a yellow dye (fluorescein) may be used.

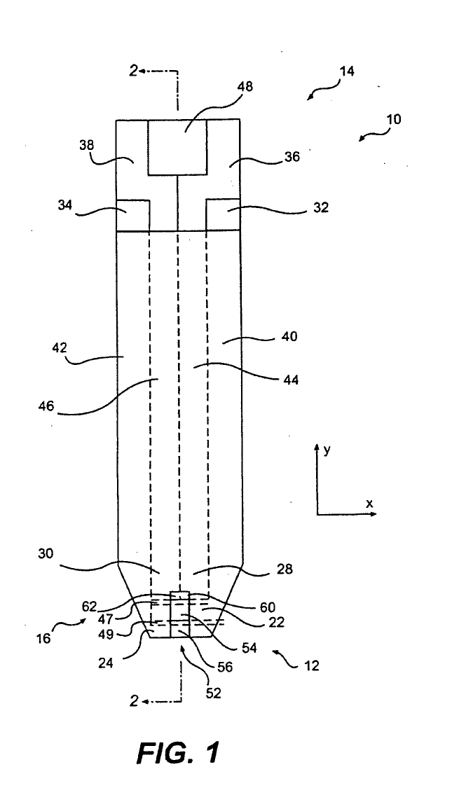

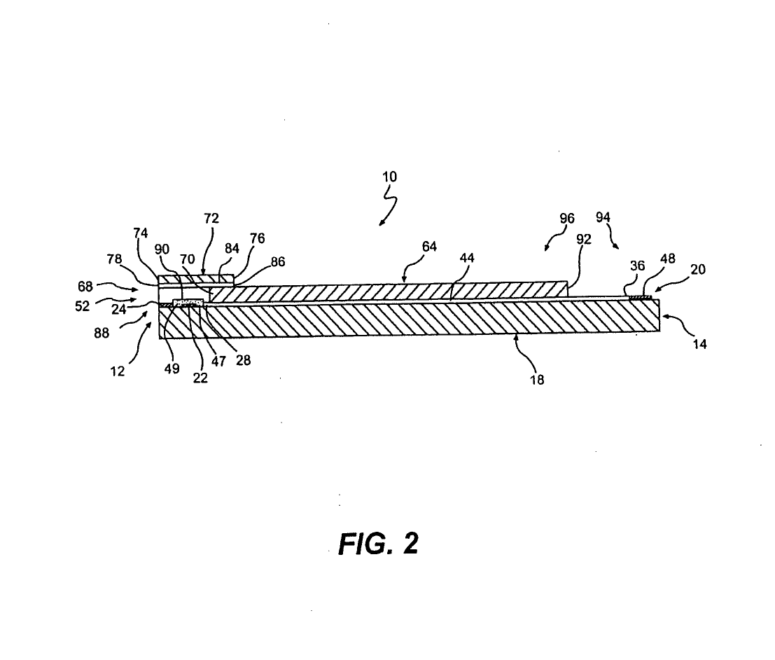

With reference to the drawings, FIGS. 1 and 2 show a test strip 10, in accordance with an illustrative embodiment of the present invention. Test strip 10 can take the form of a substantially flat strip that extends from a proximal end 12 to a distal end 14. In one embodiment, the proximal end 12 of test strip 10 can be narrower than distal end 14 to provide facile visual recognition of distal end 14. For example, test strip 10 can include a tapered section 16, in which the full width of test strip 10 tapers down to proximal end 12, making proximal end 12 narrower than distal end 14. If, for example, a blood sample is applied to an opening in proximal end 12 of test strip 10, providing tapered section 16 and making proximal end 12 narrower than distal end 14, can, in certain embodiments, assist the user in locating the opening where the blood sample is to be applied. Further or alternatively, other visual means, such as indicia, notches, contours, textures, or the like can be used.

Test strip 10 is depicted in FIGS. 1 and 2 as including a plurality of electrodes. Each electrode may extend substantially along the length of test strip 10 to provide an electrical contact near distal end 14 and a conductive region electrically connecting the region of the electrode near proximal end 12 to the electrical contact. In the illustrative embodiment of FIGS. 1 and 2, the plurality of electrodes includes a working electrode 22, a counter electrode 24, a fill-detect anode 28, and a fill-detect cathode 30. Correspondingly, the electrical contacts can include a working electrode contact 32, a counter electrode contact 34, a fill-detect anode contact 36, and a fill-detect cathode contact 38 positioned at distal end 14. The conductive regions can include a working electrode conductive region 40, electrically connecting the proximal end of working electrode 22 to working electrode contact 32, a counter electrode conductive region 42, electrically connecting the proximal end of counter electrode 24 to counter electrode contact 34, a fill-detect anode conductive region 44 electrically connecting the proximal end of fill-detect anode 28 to fill-detect contact 36, and a fill-detect cathode conductive region 46 electrically connecting the proximal end of fill-detect cathode 30 to fill-detect cathode contact 38.

As shown in FIG. 2, test strip 10 can have a generally layered construction. Working upwardly from the bottom layer, test strip 10 can include a base layer 18 that can substantially extend along the entire length or define the length of test strip 10. Base layer 18 can be formed from an electrically insulating material and can have a thickness sufficient to provide structural support to test strip 10.

According to the illustrative embodiment of FIG. 2, a conductive layer 20 may be disposed on at least a portion of base layer 18. Conductive layer 20 can comprise a plurality of electrodes. In the illustrative embodiment, the plurality of electrodes includes a working electrode 22, a counter electrode 24, a fill-detect anode 28, and a fill-detect cathode 30. Further, the illustrative embodiment is depicted with conductive layer 20 including an auto-on conductor 48 disposed on base layer 18 near distal end 14. While FIG. 2 shows a diffusion barrier 49, which may be a non-conductive region formed in conductive layer 20, such a layer is not required. In one embodiment, the optional diffusion barrier 49 may be formed by at least partially ablating conductive layer 20 between working electrode 22 and counter electrode 24. A diffusion barrier is typically designed to provide a sufficient distance between exposed portions of the electrode and counter electrode to limit migration of charged components there between. By limiting spurious components that such migration may cause, the accuracy of the glucose concentration is increased.

The next layer of the illustrative test strip 10 is a dielectric spacer layer 64 disposed on conductive layer 20. Dielectric spacer layer 64 may be composed of an electrically insulating material, such as polyester. Dielectric spacer layer 64 can cover portions of working electrode 22, counter electrode 24, fill-detect anode 28, fill-detect cathode 30, and conductive regions 40-46, but in the illustrative embodiment of FIG. 2 does not cover electrical contacts 32-38 or auto-on conductor 48. For example, dielectric spacer layer 64 can cover a substantial portion of conductive layer 20 thereon, from a line proximal of contacts 32 and 34 to proximal end 12, except for slot 52 extending from proximal end 12.

A cover 72, having a proximal end 74 and a distal end 76, is shown in FIG. 2 as being disposed at proximal end 12 and configured to cover slot 52 and partially form sample chamber 88. Cover 72 can be attached to dielectric spacer layer 64 via an adhesive layer 78. Adhesive layer 78 can include a polyacrylic or other adhesive and can consist of sections disposed on cover 72 on opposite sides of slot 52. A break 84 in adhesive layer 78 extends from distal end 70 of slot 52 to an opening 86. Cover 72 can be disposed on spacer layer 64 such that proximal end 74 of cover 72 may be aligned with proximal end 12 and distal end 76 of cover 72 may be aligned with opening 86, thereby covering slot 52 and break 84. Cover 72 can be composed of an electrically insulating material, such as polyester. Additionally, cover 72 can be transparent.

Slot 52, together with base layer 18 and cover 72, can define sample chamber 88 in test strip 10 for receiving a fluid sample, such as a blood sample, for measurement in the illustrative embodiment. A proximal end 68 of slot 52 can define a first opening in sample chamber 88, through which the fluid sample is introduced. At distal end 70 of slot 52, break 84 can define a second opening in sample chamber 88, for venting sample chamber 88 as sample enters sample chamber 88. Slot 52 may be dimensioned such that a blood sample applied to its proximal end 68 is drawn into and held in sample chamber 88 by capillary action, with break 84 venting sample chamber 88 through opening 86, as the blood sample enters. Moreover, slot 52 can be dimensioned so that the volume of blood sample that enters sample chamber 88 by capillary action is about 1 micro-liter or less.

A reagent layer 90 may be disposed in the inventive gel matrix, which is within sample chamber 88. In the illustrative embodiment, reagent layer 90 contacts exposed portion 54 of working electrode 22. It is also contemplated that reagent layer 90 may or may not contact diffusion barrier 49 and/or exposed portion 56 of counter electrode 24. Reagent layer 90 may include chemical components to enable the level of glucose or other analyte in the fluid, such as a blood sample, to be determined electro-chemically. For example, reagent layer 90 can include an enzyme specific for glucose, such as glucose dehydrogenase or glucose oxidase, and a mediator, such as potassium ferricyanide or ruthenium hexamine. Reagent layer 90 can also include other components, such as buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485).

As explained, chemical components of reagent layer 90 can react with glucose in the blood sample in the following way. The glucose oxidase initiates a reaction that oxidizes the glucose to gluconic acid and reduces the ferricyanide to ferrocyanide. When an appropriate voltage is applied to working electrode 22, relative to counter electrode 24, the ferrocyanide is oxidized to ferricyanide, thereby generating a current that is related to the glucose concentration in the blood sample.

As depicted in FIG. 2, the position and dimensions of the layers of illustrative test strip 10 can result in test strip 10 having regions of different thicknesses. Of the layers above base layer 18, the thickness of spacer layer 64 may constitute a substantial thickness of test strip 10. Thus the distal end of spacer layer 64 may form a shoulder 92 in test strip 10. Shoulder 92 may delineate a thin section 94 of test strip 10 extending from shoulder 92 to distal end 14, and a thick section 96 of test strip 10 extending from shoulder 92 to proximal end 12. The elements of test strip 10 used to electrically connect it to the meter (not shown), namely, electrical contacts 32-38 and auto-on conductor 48, can all be located in thin section 94. Accordingly, the meter can be sized and configured to receive thin section 94 but not thick section 96. This may allow the user to insert the correct end of test strip 10, i.e., distal end 14 in thin section 94, and can prevent the user from inserting the wrong end, i.e., proximal end 12 in thick section 96, into the meter.

Test strip 10 can be sized for easy handling. For example, test strip 10 can measure approximately 35 mm long (i.e., from proximal end 12 to distal end 14) and about 9 mm wide. According to the illustrative embodiment, base layer 18 can be a polyester material about 0.25 mm thick and dielectric spacer layer 64 can be about 0.094 mm thick and cover portions of working electrode 22. Adhesive layer 78 can include a polyacrylic or other adhesive and have a thickness of about 0.013 mm. Cover 72 can be composed of an electrically insulating material, such as polyester, and can have a thickness of about 0.095 mm. Sample chamber 88 can be dimensioned so that the volume of fluid sample is about 1 micro-liter or less. For example, slot 52 can have a length (i.e., from proximal end 12 to distal end 70) of about 3.56 mm, a width of about 1.52 mm, and a height (which can be substantially defined by the thickness of dielectric spacer layer 64) of about 0.13 mm. The dimensions of test strip 10 for suitable use can be readily determined by one of ordinary skill in the art. For example, a meter with automated test strip handling may utilize a test strip smaller than 9 mm wide.

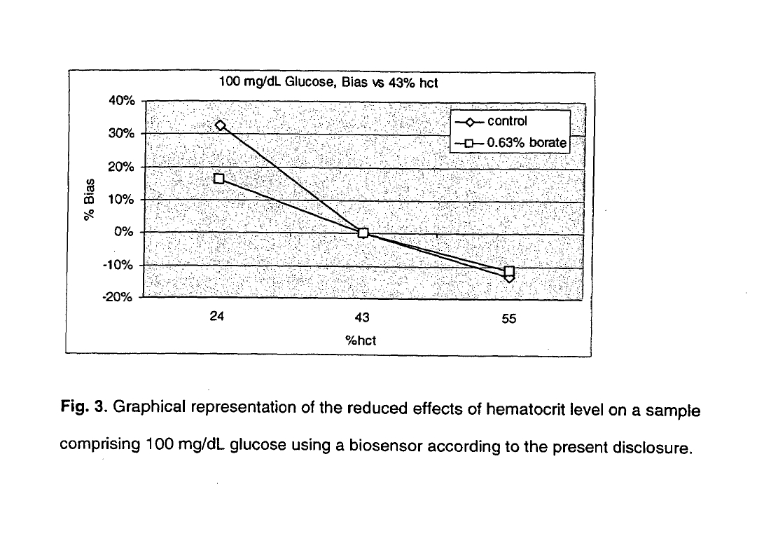

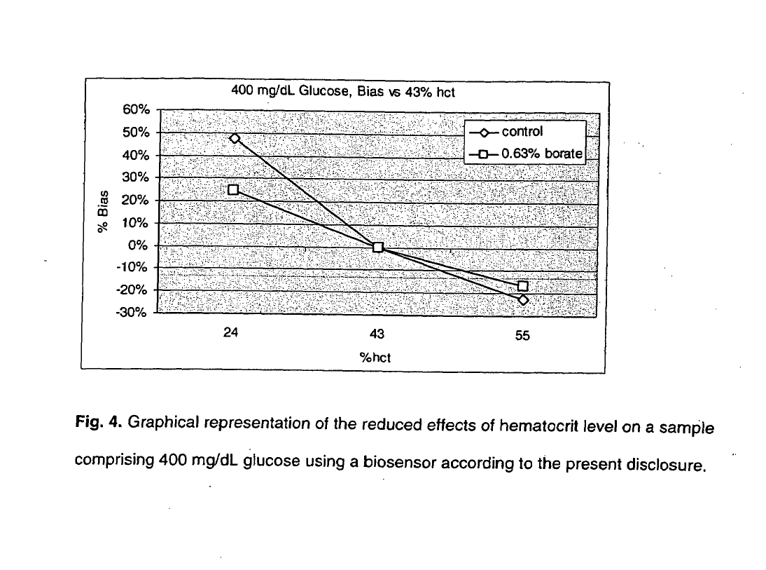

With reference to FIGS. 3 and 4, these graphs show the reduced effect of hematocrit using a 0.63% borate gel according to the present disclosure, on samples containing 100 mg/dL glucose and 400 mg/dL glucose, respectively. As shown in FIGS. 3 and 4, variations between a positive bias and a negative bias is shown across hematocrits levels from 24 to 55% for both levels of glucose. By using an inventive biosensor that comprises a gel matrix, the resulting glucose measurements show a reduced effect of hematocrit levels, at both high levels (negative bias) and low levels (positive bias). Thus, the resulting measurements becomes less dependent on variations in hematocrit levels when a biosensor comprising a gel matrix is used.

Also disclosed are methods of preparing chemistry for the reagent layer comprising the disclosed borate/PVA gel. These methods comprise applying to a biosensor according to the present disclosure, such as one constructed in same manner described in U.S. Pat. No. 6,743,635 ('635 patent), a gel sufficient for filtering red blood cells.

For example, there is disclosed a method of making a plurality of biosensors (also referred to as “test strips”), that comprises forming a plurality of test strip structures on a first insulating sheet, wherein each test strip structure is formed by:

(a) forming a first conductive pattern on the first insulating sheet, the first conductive pattern including at least four electrodes, including a working electrode, a counter electrode, a fill-detect anode, and a fill-detect cathode;

(b) forming a second conductive pattern on the first insulating sheet, the second conductive pattern including a plurality of electrode contacts for the at least four electrodes, a plurality of conductive traces electrically connecting the at least four electrodes to the plurality of electrode contacts, and an auto-on conductor;

(c) applying a first dielectric layer over portions of the working electrode and the counter electrode, so as to define an exposed working electrode portion and an exposed counter electrode portion;

(d) applying a second dielectric layer to the first dielectric layer, the second dielectric layer defining a slot, the working electrode, the counter electrode, the fill-detect anode, and the fill-detect cathode being disposed in the slot;

(e) forming a reagent system in the slot, the reagent system comprising, in a gel matrix:

an oxidation-reduction enzyme specific for the constituent; and

at least one electron mediator capable of being reversibly reduced and oxidized such that an electrochemical signal resulting from the reduction or oxidation is related to the constituent concentration in the blood sample,

wherein the gel matrix is sufficient to prevent at least some of the red cells in the blood sample from contacting at least one electrode;

(f) forming an adhesive layer on the second dielectric layer, the adhesive layer having a break extending from the slot; and

(g) attaching a second insulating sheet to the adhesive layer, such that the second insulating sheet covers the slot but not the electrode contacts or auto-on conductor; and

(h) separating the plurality of test strip structures into the plurality of test strips, each of the test strips having a proximal end and a distal end, with the slot extending to the proximal end, the proximal end being narrower than the distal end.

In another embodiment, the method of making a plurality of test strips may comprise forming a plurality of test strip structures on one sheet, each of which includes:

(a) a spacer defining a sample chamber;

(b) a plurality of electrodes formed on the sheet, including a working electrode, a counter electrode, a fill-detect anode, and a fill-detect cathode;

(c) a plurality of electrical contacts, formed on the sheet and electrically connected to the plurality of electrodes; and

(d) at least one auto-on electrical contact, formed on the sheet and electrically isolated from the plurality of electrodes; and separating the test strip structures into the plurality of test strips,

wherein the sample chamber includes a reaction reagent system as previously described.

In various embodiments, the reagent system used in the disclosed methods comprises polyvinyl alcohol in an amount ranging from 0.10-5.0% by weight, borate in an amount ranging from 0.6-0.7% by weight, and a surfactant, such as Triton X-100 in an amount ranging from 0-0.5% by weight.

In general, the chemistry comprising the gel comprises the ingredients listed in Table 1.

TABLE 1

| Ingredient | Possible range |
|---|---|
| Buffer | 10-250 mM |
| pH | 5-9 |
| Surfactant | 0-0.5% |
| Mediator | 25-250 mM |
| Enzyme | 250-10,000 u/mL |
| PVA | 0.10-5.0% |
| Sodium metaborate | 0.25-1.5% |

In one embodiment, the ingredients listed in Table 1 are mixed with water to form an aqueous solution, which can be deposited onto a biosensor or test strip using known techniques, including by drop, inkjet, spray, or gravure.

In one embodiment, the ingredients listed in Table 1 form a gel upon drying to remove the water such that dried solution concentrates the PVA and borate to form crosslinks.

In another embodiment, precursor ingredients are mixed such that a gel forms upon mixing, not drying. This embodiment uses a first solution comprising the ingredients listed in Table 2.

TABLE 2

| Ingredient | Possible range |
|---|---|
| Buffer | 10-250 mM |
| pH | 5-9 |
| Surfactant | 0-0.5% |
| Mediator | 25-250 mM |
| Enzyme | 250-10,000 u/mL |
| PVA | 0.10-5.0% |

The solution produced from the ingredients of Table 2 is deposited onto a biosensor. While the solution is still wet, sodium metaborate in an amount ranging from 1.0-25% by weight is deposited on the solution, which results in gel.

In another embodiment, the previously described solution may be dried before the sodium metaborate is applied. It is noted that in the above described embodiment, the order of deposition of the sodium metaborate and the solution is irrelevant. In other words, the sodium metaborate may be applied to the biosensor first, alternatively dried, followed by applying a solution of the ingredients listed in Table 2. Either way, a gel forms almost immediately upon the mixing of the solution with the sodium metaborate.

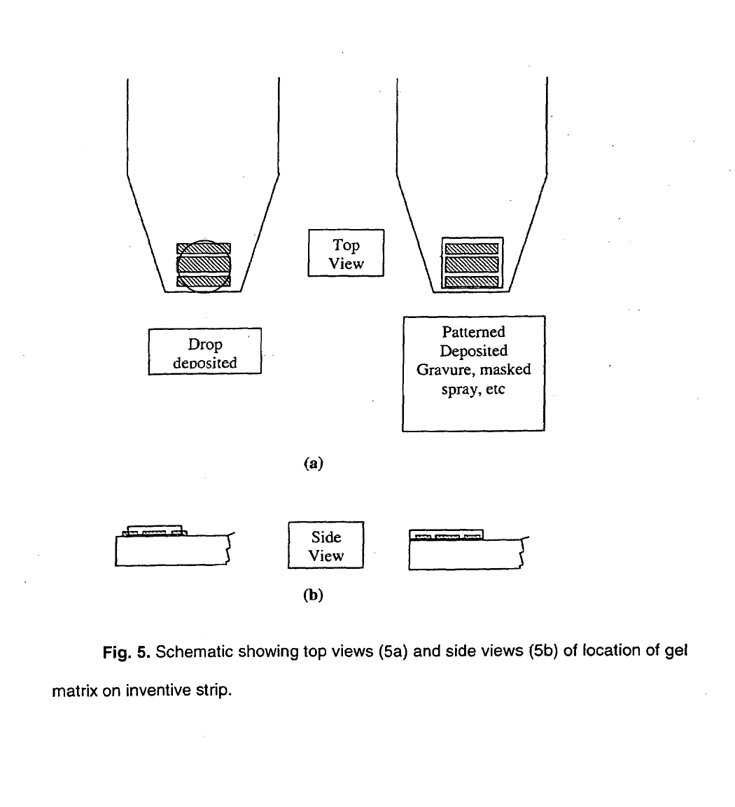

With reference to FIG. 5, in accordance with an illustrative embodiment of the present invention, the location of the gel matrix may be shown having a circular shape extending from cathode to cathode (5a). This is typically the case when the previously described solution are deposited drop-wise. Alternatively, a patterned deposited gel matrix may be used to entirely encompass the cathodes. A side view of both embodiments show a thin layer in the same locations (5b).

As previously stated, techniques of deposition for all methods might be by drop, inkjet, spray, gravure or other techniques.

The present disclosure is further illuminated by the following non-limiting examples, which are intended to be purely exemplary of the invention.

### Example 1

### Preparing Chemistry Comprising Borate/PVA Gel Upon Drying

This example describes a method of preparing chemistry comprising borate/PVA gel that forms a gel according to the present disclosure.

The chemistry according to this Example comprised the ingredients in Table 3.

TABLE 3
Chemistry Ingredients Comprising Borate/PVA

| Ingredient | Concentration |
|---|---|
| Buffer | 100 mM |
| pH | 6.0 |
| Surfactant | 0.15% |
| Mediator | 125 mM |
| Enzyme | 2500 u/mL (Glu Ox) |
| PVA | 1.5% |
| Sodium metaborate | 0.63% |

The ingredients in Table 3 were mixed together with water to form an aqueous solution having the listed concentrations. With this chemistry, a gel formed as the water evaporated during drying, due to crosslinking between the PVA and borate.

FIGS. 3 and 4 show a graphical representation of the reduced effects of hematocrit level on a sample comprising 100 and 400 mg/dL glucose, respectively, using biosensors made according to this example.

### Example 2

### Preparing Chemistry Comprising Borate/PVA Gel Upon Mixing

This example describes a method of preparing chemistry comprising borate/PVA gel that forms a gel according to the present disclosure when the ingredients were mixed.

The chemistry according to this Example comprised the precursor ingredients mentioned in Table 4.

TABLE 4
Chemistry for Gel Precursor Ingredients

| Ingredient | Concentration |
|---|---|
| Buffer | 100 mM |
| pH | 6.0 |
| Surfactant | 0.15% |
| Mediator | 125 mM |
| Enzyme | 2500 u/mL (Glu Ox) |
| PVA | 1.5% |

The ingredients in Table 4 were mixed together to form a solution that was deposited onto a sensor. While the solution was still wet, 10% by weight of sodium metaborate was deposited onto it, causing a gel to form.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention.

Unless expressly noted, the particular biosensor structures and manufacturing methods are listed merely as examples and are not intended to be limiting of the invention as claimed. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A biosensor for measuring a constituent concentration in blood, said biosensor comprising, on a support substrate:
a sample reception region for receiving a blood sample;
at least one electrode; and
a reaction reagent system comprising, in a gel matrix:
an oxidation-reduction enzyme specific for the constituent; and
at least one electron mediator capable of being reversibly reduced and oxidized such that an electrochemical signal resulting from the reduction or oxidation is related to the constituent concentration in the blood sample,
wherein said gel matrix is sufficient to prevent at least some of the red cells in the blood sample from contacting the electrode.

2. The biosensor of claim 1, wherein the gel matrix comprises polyvinyl alcohol.

3. The biosensor of claim 2, wherein the gel matrix further comprises borate.

4. The biosensor of claim 1, wherein the gel matrix further comprises a glycerol-based plasticizer.

5. The biosensor of claim 1, wherein the gel matrix further comprises particles chosen from fumed silica, cellulose fiber, and glass powder.

6. The biosensor of claim 1, wherein the gel matrix is in a dehydrated form prior to being contacted with said blood sample.

7. The biosensor of claim 1, wherein the at least one electrode is conducting and comprises a metal chosen from or derived from gold, platinum, rhodium, palladium, silver, iridium, carbon, steel, metallorganics, and mixtures thereof.

8. The biosensor of claim 1, wherein the at least one electrode is semiconducting and comprises a material chosen from tin oxide, indium oxide, titanium dioxide, manganese oxide, iron oxide, zinc oxide, and combinations thereof.

9. The biosensor of claim 8, wherein the at least one semiconducting electrode comprises zinc oxide doped with indium, tin oxide doped with indium, indium oxide doped with zinc, or indium oxide doped with tin.

10. The biosensor of claim 1, wherein the constituent is chosen from glucose, cholesterol, lactate, acetoacetic acid (ketone bodies), theophylline, and hemoglobin A1c.

11. The biosensor of claim 10, wherein the constituent comprises glucose and the at least one oxidation-reduction enzyme specific for the analyte is chosen from glucose oxidase, PQQ-dependent glucose dehydrogenase and NAD-dependent glucose dehydrogenase.

12. The biosensor of claim 1, wherein the electron mediator comprises a ferricyanide material, ferrocene carboxylic acid or a ruthenium containing material.

13. The biosensor of claim 12, wherein the ferricyanide material comprises potassium ferricyanide.

14. The biosensor of claim 12, wherein the ruthenium containing material comprises ruthenium hexaamine (III) trichloride.

15. The biosensor of claim 1, wherein the reaction reagent system further comprises at least one buffer material comprising potassium phosphate.

16. The biosensor of claim 1, wherein the reaction reagent system further comprises at least one surfactant chosen from non-ionic, anionic, and zwitterionic surfactants.

17. The biosensor of claim 1, wherein the reaction reagent system further comprises at least one polymeric binder and/or viscosifier chosen from hydroxyethyl cellulose, hydroxypropyl-methyl cellulose, sodium alginate, microcrystalline cellulose, polyethylene oxide, polyethylene glycols (PEG), polypyrrolidone, and polyvinyl alcohol.

18. The biosensor of claim 1, further comprising an additional electron mediator chosen from brilliant cresyl blue, gentisic acid (2,5-dihydroxybenzoic acid), and 2,3,4-trihydroxybenzoic acid.

19. The biosensor of claim 1, comprising two or more electrodes chosen from a working electrode, a proximal electrode, and a fill-detect electrode.

20. The biosensor of claim 1, further including at least one of an electrical contact, an auto-on conductor, and a coding region.

21. The biosensor of claim 1, wherein the support substrate comprises a polyethylene terepthalate (PET), glycol-modified polyethylene terepthalate (PETG), polyvinyl chloride (PVC), polyurethanes, polyamides, polyimide, polycarbonates, polyesters, polystyrene, or copolymers of these polymers.

22. The biosensor of claim 1, wherein the biosensor further includes a dielectric spacer layer at least partially deposited on the at least one electrode.

23. The biosensor of claim 22, wherein the dielectric spacer layer comprises a polyethylene terepthalate (PET), glycol-modified polyethylene terepthalate (PETG), polyvinyl chloride (PVC), polyurethanes, polyamides, polyimide, polycarbonates, polyesters, polystyrene, or copolymers of these polymers.

24. The biosensor of claim 22, wherein the biosensor further includes an adhesive layer disposed between the dielectric spacer layer and the at least one electrode.

25. A method of making a plurality of biosensors, said method comprising:
forming a plurality of biosensor structures on a first insulating sheet, wherein each biosensor structure is formed by:
(a) forming a first conductive pattern on said first insulating sheet, said first conductive pattern including at least four electrodes, said at least four electrodes including a working electrode, a counter electrode, a fill-detect anode, and a fill-detect cathode;
(b) forming a second conductive pattern on said first insulating sheet, said second conductive pattern including a plurality of electrode contacts for said at least four electrodes, a plurality of conductive traces electrically connecting said at least four electrodes to said plurality of electrode contacts, and an auto-on conductor;
(c) applying a first dielectric layer over portions of said working electrode and said counter electrode, so as to define an exposed working electrode portion and an exposed counter electrode portion;
(d) applying a second dielectric layer to said first dielectric layer, said second dielectric layer defining a slot, said working electrode, said counter electrode, said fill-detect anode, and said fill-detect cathode being disposed in said slot;
(e) forming a reagent system in said slot, said reagent system comprising, in a gel matrix:
an oxidation-reduction enzyme specific for the constituent; and
at least one electron mediator capable of being reversibly reduced and oxidized such that an electrochemical signal resulting from the reduction or oxidation is related to the constituent concentration in the blood sample,
wherein said gel matrix is sufficient to prevent at least some of the red cells in the blood sample from contacting at least one electrode;
(f) forming an adhesive layer on said second dielectric layer, said adhesive layer having a break extending from said slot; and
(g) attaching a second insulating sheet to said adhesive layer, such that said second insulating sheet covers said slot but not said electrode contacts or said auto-on conductor; and
(h) separating said plurality of biosensor structures into said plurality of biosensors, each having a proximal end and a distal end, with said slot extending to said proximal end, said proximal end being narrower than said distal end.

26. The method of claim 25, wherein the reagent system comprises polyvinyl alcohol in an amount ranging from 0.10-5.0% by weight.

27. The method of claim 25, wherein the reagent system comprises borate in an amount ranging from 0.6-0.7% by weight.

28. The method of claim 25, wherein the reagent system comprises a surfactant in an amount ranging from 0-0.5% by weight.

29. The method of claim 25, wherein the gel matrix is dehydrated.

30. A method of making a plurality of biosensors, said method comprising:
forming a plurality of biosensor structures on one sheet, each of said biosensor structures including:
(a) a spacer defining a sample chamber;
(b) a plurality of electrodes formed on said sheet, including a working electrode, a counter electrode, a fill-detect anode, and a fill-detect cathode;
(c) a plurality of electrical contacts, formed on said sheet and electrically connected to said plurality of electrodes; and
(d) at least one auto-on electrical contact, formed on said sheet and electrically isolated from said plurality of electrodes; and separating said biosensor structures into said plurality of biosensors,
wherein said sample chamber includes a reaction reagent system comprising, in a gel matrix:
an oxidation-reduction enzyme specific for the constituent; and
at least one electron mediator capable of being reversibly reduced and oxidized such that an electrochemical signal resulting from the reduction or oxidation is related to the constituent concentration in the blood sample,
wherein said gel matrix is sufficient to prevent at least some of the red cells in the blood sample from contacting the electrode.

31. The method of claim 30, wherein separating said biosensor structures into said plurality of biosensors comprises: punching said plurality of biosensor structures to form a plurality of tapered biosensor structures and slitting said tapered biosensor structures to for a plurality of biosensors.

32. The method of claim 30, wherein the reagent system comprises polyvinyl alcohol in an amount ranging from 0.10-5.0% by weight.

33. The method of claim 30, wherein the reagent system comprises borate in an amount ranging from 0.6-0.7% by weight.

34. The method of claim 30, wherein the reagent system comprises a surfactant in an amount ranging from 0-0.5% by weight.
